(19) United States
(12) Patent Application Publication
(10) Pub. No.: US 2012/0075686 A1
(43) Pub. Date: Mar. 29, 2012

(54) Beam Profile Control in a Scanned Beam Display

(75) Inventors: Joshua M. Hudman, Sammamish, WA (US); Joshua O. Miller, Woodinville, WA (US); Richard A. James, Woodinville, WA (US); Robert A. Sprowl, Sammamish, WA (US); Markus Duelli, Seattle, WA (US)

(73) Assignee: MICROVISION, INC., Redmond, WA (US)

(21) Appl. No.: 12/893,354

(22) Filed: Sep. 29, 2010

(51) Int. Cl. G02B 26/10

(52) U.S. Cl. 359/205.1; 359/197.1

(57) ABSTRACT

Briefly, in accordance with one or more embodiments, a display projector may comprise a light source to generate a beam to be scanned, a scanning platform to scan the beam in a selected pattern to project an image on a projection surface, and a collection lens and microlens array to shape the beam to a desired beam profile without significantly increasing spot size of the beam with increasing distance from the projection surface.

### BACKGROUND

In scanned beam displays or the like, the beam profile and the collection efficiency are typically enhanced via utilization of a top hat lens and/or a circularizer located at or near the beam source. However, using such separate optics may adversely impact sensitivity to alignment with other optics and/or elements that may be present in the display system. Furthermore, the guidelines set forth in regulatory standards may limit the collection efficiency of the beam shaping optics.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a diagram of a scanned beam display having a microlens array (MLA) on a collection lens to control the beam profile in accordance with one or more embodiments;

FIG. 2 is a diagram of a scanned beam display having a microlens array (MLA) disposed after a collection lens and prior to a scanning platform to control the beam profile in accordance with one or more embodiments;

FIG. 3 is a diagram of a scanned beam display having a microlens array (MLA) spaced apart from a collection lens and prior to a scanning platform to control the beam profile in accordance with one or more embodiments;

FIGS. 4A and 4B are diagrams of a collection lens having a microlens array (MLA) in combination therewith in accordance with one or more embodiments;

FIG. 5 is a graph illustrating full width at half maximum spot size versus distance in a scanned beam display having a collimating lens and a microlens array in accordance with one or more embodiments;

FIG. 6 is a diagram of a scanned beam display utilizing a microlens array (MLA) in combination with a collection lens to control the beam profile in accordance with one or more embodiments; and

FIG. 7 is a diagram of an information handling system having a scanned beam display utilizing a microlens array (MLA) in combination with a collection lens to control the beam profile in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

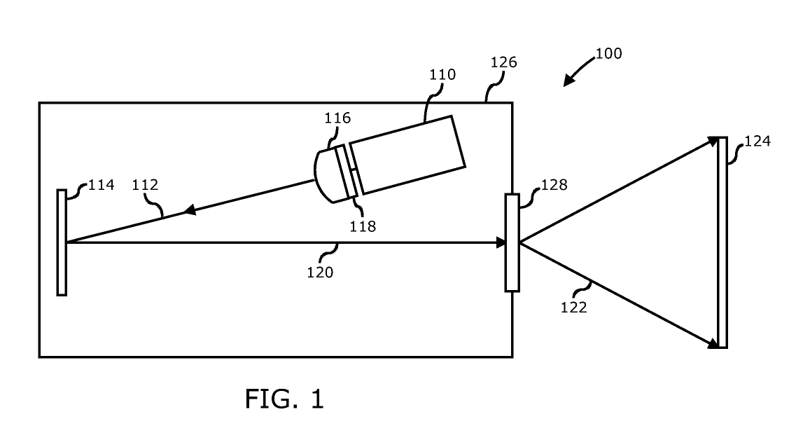

Referring now to FIG. 1, a diagram of a scanned beam display having a microlens array (MLA) on a collection lens to control the beam profile in accordance with one or more embodiments will be discussed. As shown in FIG. 1, a scanned beam display 100 may comprise a light source 110 to generate a beam 112 that may be scanned by scanning platform 114 in an exit cone 122 onto a projection surface 124. It should be noted that FIG. 1 and similar figures, below, are schematic in nature and not necessary illustrative of dimension, proportion or scale. Furthermore, although the examples herein illustrate embodiments of a scanned beam display 100, it should be noted that other embodiments may employ other types of displays or laser projection systems such as a liquid crystal on silicon (LCOS) display or a digital light processing (DLP) display among of several examples, and the scope of the claimed subject matter is not limited in this respect. In one or more embodiments, as will be discussed in further detail below, light source 110 may be a laser source to generate beam 112 as a laser beam, or alternatively light source 110 may be any suitable light source to generate beam 112, such as a light emitting diode as one of many examples, and the scope of the claimed subject matter is not limited in this respect. In one or more embodiments, a collection lens 116 may be disposed in the path of beam 112 to collect and/or and collimate beam 112. An example suitable collection lens may 116 be a part number LPX 3.6-2.0-BAK1 lens available from CVI Melles Griot of Albuquerque, N. Mex., US, although the scope of the claimed subject matter is not limited in this respect. Furthermore, a microlens array 118 may be disposed in the path of beam 112 after the beam 112 exits light source 110 and prior to the beam 112 hitting collection lens 116. In one or more embodiments, microlens array 118 may be disposed separately from collection lens 116, or alternatively microlens array 118 may be disposed directly adjacent to collection lens 116. In a further alternative embodiment, collection lens 116 and microlens array 118 may be formed as an integrated unit, although the scope of the claimed subject matter is not limited in these respects.

In one or more embodiments, scanned beam display 100 optionally may be disposed in a housing 126 having an exit port or window 128 through which exit beam 120 may be directed by scanning platform 114 to exit housing 126 in exit cone 122 to project an image onto a projection surface 124. By utilization of collection lens 116 in combination with microlens array 118, the beam shape and/or profile may be controlled or altered in an intended manner to define where the Gaussian 1/e profile of beam 112 is collected and impinging on scanning platform 114. In one or more embodiments, the beam spot size may be increased by pulling energy away from the center of the beam 112 toward the outer periphery of the beam 112 to result in a desired or selected Gaussian profile. One measure of the beam profile is referred to as C6 which is a scale factor of the International Electrotechnical Commission (IEC) and is the ratio of the angles of the actual beam versus the diffraction limited beam based on the limit of the human eye. The angles are calculated by calculating the angle between the 1/e value of a Gaussian beam over the minimum focus of the human eye, which is about 100 mm. In one or more embodiments, utilizing a microlens array 118 in combination with collimating lens 116 may push the 1/e value of the Gaussian beam 112 at scanning platform 114 away from the center of the beam to result in a larger C6 value. As a result, using MLA 118 to provide higher order change in the irradiance pattern of the beam in the near filed may provide a desired C6 value without resulting in a significant change in the spot size in the far field in the image at projection surface 124. If beam 112 produces a tight, non-diffracted spot, the C6 value of the beam 112 is at or near C6=1. By changing the 1/e value of the beam 112, the C6 value may be increased. In one or more embodiments, microlens array 118 may provide an approximate increase in the C6 value of the beam 112 of approximately about 40% to about 50% increase the C6 value. In one or more alternative embodiments, the increase in C6 value via operation of the microlens array 120 is approximately a doubling in the C6 value as would be achieved without microlens array 120, although the scope of the claimed subject matter is not limited in these respects.

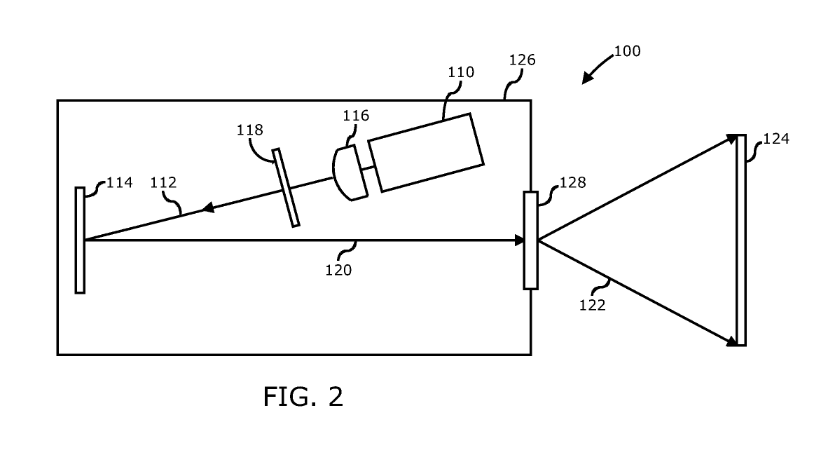

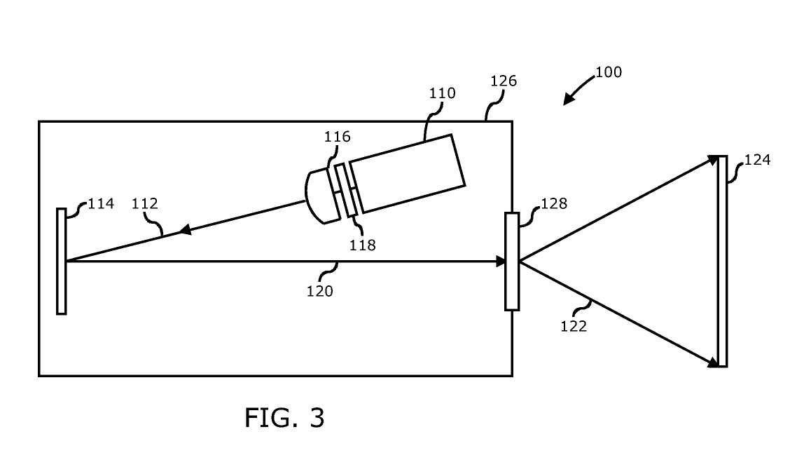

Referring now to FIG. 2, a diagram of a scanned beam display having a microlens array (MLA) disposed after a collection lens and prior to a scanning platform to control the beam profile in accordance with one or more embodiments will be discussed. As shown in FIG. 2, scanned beam display 100 of FIG. 2 is substantially similar to the scanned beam display 100 of FIG. 1, except that in FIG. 2 microlens array 118 is disposed after beam 112 passes through collimating lens 116 rather than before collimating lens 116 as shown in FIG. 1. In general, microlens array 118 may be disposed either before collimating lens 116 as shown in FIG. 1, or after collimating lens 116 as shown in FIG. 2, wherein in both embodiments the microlens array 118 is disposed in the near field such that microlens array 118 is capable of beam profile control of beam 112 before beam 112 impinges on scanning platform 114. In some embodiments, microlens array 118 may be disposed adjacent and/or coupled to collimating lens 116 and disposed in the path of beam 112 after collimating lens 116. In other embodiments, microlens array 118 may be disposed at least some distance away from collimating lens 116. In alternative embodiments, microlens array 118 may be disposed adjacent to and/or coupled to scanning platform 114. In yet further embodiments, microlens array 118 may be integrated with scanning platform 114, and in some embodiments may be disposed to be coupled to scanning platform 114. However, the scope of the claimed subject matter is not limited in these respects. In the embodiments shown in FIG. 1 and FIG. 2, microlens array 118 is capable of maintaining the spot size of beam 112 in the far field at or near a selected C6 value without providing any effect or any substantial effect of the beam spot size in the far field. In one or more alternative embodiments, microlens array 118 may be spaced apart from collimating lens 116 as shown in and described with respect to FIG. 3, below.

Referring now to FIG. 3, a diagram of a scanned beam display having a microlens array (MLA) spaced apart from a collection lens and prior to a scanning platform to control the beam profile in accordance with one or more embodiments will be discussed. The embodiment shown in FIG. 3 is substantially similar to the embodiment shown in FIG. 1, except that the microlens array 118 is disposed at some distance spaced apart from collimating lens 116 rather than being coupled to or integrated with collimating lens 116. In such embodiments, the focal lengths of the lenslets of microlens array 118 and/or collimating lens 116, or other optical properties, may dictate an arrangement in which the two elements may be spaced at some distance apart to optimize or nearly optimize performance of scanned beam display 100. It should also be noted that the relative positions of microlens array 118 and collimating lens 116 as shown in the examples of FIG. 1, FIG. 2, and FIG. 3 may be based on design considerations of scanned beam display 100, and the scope of the claimed subject matter is not limited in these respects. Furthermore, although FIG. 1, FIG. 2, and FIG. 3 show microlens array 118 being disposed prior to scanning platform 114 in the path of beam 112, it should be noted that microlens array 118 may be disposed after scanning platform 114 in beam path 120. In yet another embodiment, collimating lens 116 and 118 may be fabricated as a single integrated device. In any event, the scope of the claimed subject matter is not limited in these respects.

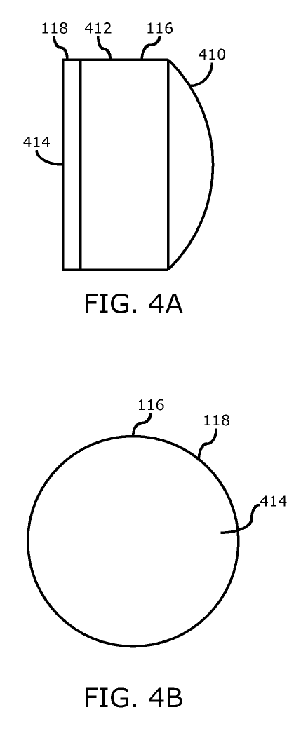

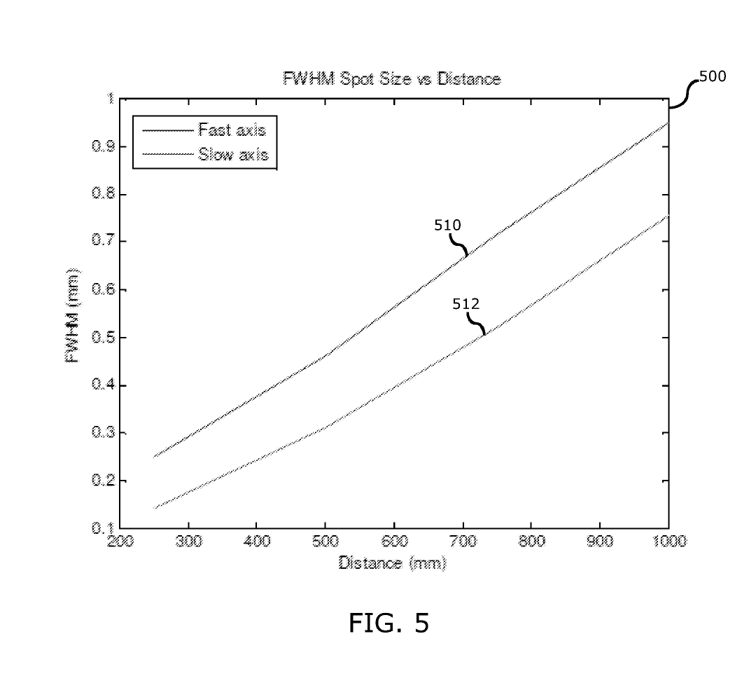

Referring now to FIGS. 4A and 4B, diagrams of a collection lens having a microlens array (MLA) in combination therewith in accordance with one or more embodiments will be discussed. FIG. 4A is a side view of collection lens 116 and microlens array 118, and FIG. 4B is an end view of the collection lens 116 and microlens array 118 viewed from the side of microlens array 118. The collection lens 116 may comprise a plano-convex lens having a curved portion 410 and a central body 412. In one or more embodiments, collection lens 116 may have a center thickness from one end of central body 412 to the apex of the curved portion 410 of about 2 millimeters or so, and curved portion 410 may have a radius of about 2.290 millimeters as one of many examples, although the scope of the claimed subject matter is not limited in these respects. Microlens array 118 may be disposed adjacent to collection lens 116 as a separate device, or alternatively may be bonded to or integrated with or otherwise manufactured as part of collection lens 116, although the scope of the claimed subject matter is not limited in these respects. As one particular example, microlens array 118 may comprise a negative lenslet array 414 wherein the lenslets have a radius of curvature of about 25 millimeters and are spaced apart at a pitch of about 0.125 millimeters, although the scope of the claimed subject matter is not limited in these respects. It should be noted that microlens array 118 is utilized along with collection lens 116 in lieu of other optical elements that would otherwise be utilized such as a top hat lens or a circularizer lens, and may function to pull energy of beam 112 away from the center of the beam and therefore may function as a negative lens. Using microlens array 118 in lieu of such other optical elements may provide lower sensitivity to mechanical tolerances than the other optical elements while maintaining the far field spot size in the image projected on projection surface 124. An illustration of how the spot size is maintained is shown in and described with respect to FIG. 5, below.

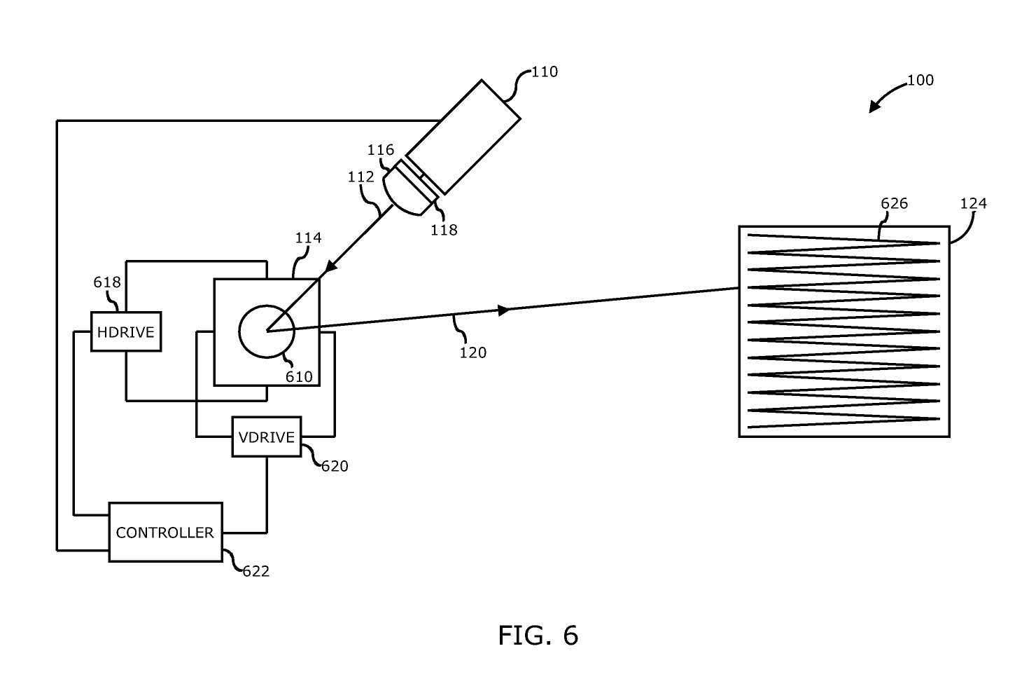

Referring now to FIG. 5, a graph illustrating full width at half maximum spot size versus distance in a scanned beam display having a collimating lens and a microlens array in accordance with one or more embodiments will be discussed. As show in FIG. 5, graph 500 illustrates that spot size growth does not increase significantly with increasing distance of the scanned beam display 100 away from the projection surface 124. In other words, spot size growth does not significantly increase faster than what is expected due to increasing distance of the scanned beam display 110 from the projection surface 124. Such a result is illustrated by plot 510 which shows the spot size growth in one dimension with respect to distance of the display 100 from projection surface 124, and by plot 512 which shows the spot size growth in another dimension orthogonal to the first dimension. In one or more embodiments, scanning platform 114 may be a two-dimensional scanner having a fast scan axis and slow scan axis wherein plot 510 shows the spot size growth for the fast scan axis and plot 512 shows the spot size growth for the slow scan axis. The spot size growth is determined by the full width at half maximum (FWHM) value of the beam spot. Utilization of microlens array 118 pushes the energy of the beam 112 away from the center toward the outside portions of the Gaussian energy distribution of the spot without resulting in any significant amount of spot size growth, that is without significantly altering the FWHM value. As shown in FIG. 5, plots 510 and 512 are nearly and/or generally linear over increasing distance of display 100 from projection surface 124. As a result, a combination of microlens array 118 and collection lens 116 may be utilized to shape the beam profile of beam 112 without resulting in any significant increase in spot size. An example scanned beam display that may utilize such a combination of a microlens array 118 and collection lens 116 is shown in and described with respect to FIG. 6, below.

Referring now to FIG. 6, a diagram of a scanned beam display utilizing a microlens array (MLA) in combination with a collection lens to control the beam profile in accordance with one or more embodiments will be discussed. Although FIG. 6 illustrates one type of a scanned beam display system for purposes of discussion, for example a microelectromechanical system (MEMS) based display, it should be noted that other types of scanning displays including those that use two uniaxial scanners, rotating polygon scanners, or galvonometric scanners as well as other display types such as a spatial light modulator or liquid crystal on silicon (LCOS) display as some of many examples, may also utilize the claimed subject matter and the scope of the claimed subject matter is not limited in this respect. Scanned beam display 100 may be adapted to include a collimating lens 116 and microlens array 118 as discussed herein, above. Details of operation of scanned beam display 100 are discussed, below.

As shown in FIG. 6, scanned beam display 100 comprises a light source 110, which may be a laser light source such as a laser or the like, capable of emitting a beam 112 which may comprise a laser beam. In some embodiments, light source 110 may comprise two or more light sources, such as in a color system having red, green, and blue light sources, wherein the beams from the light sources may be combined into a single beam. In one or more embodiments, light source 110 may include a first full color light source such as a red, green, and blue light source, and optionally may include one or more light sources that emit an invisible beam such as an ultraviolet beam or an infrared beam. The beam 112 is incident on a scanning platform 114 which may comprise a microelectromechanical system (MEMS) based scanner or the like in one or more embodiments, and reflects off of scanning mirror 610 to generate a controlled output beam 120. In one or more alternative embodiments, scanning platform 114 may comprise a diffractive optic grating, a moving optic grating, a light valve, a rotating mirror, a spinning silicon device, a digital light projector device, a flying spot projector, or a liquid-crystal on silicon (LCOS) device, or other similar scanning or modulating devices. A horizontal drive circuit 618 and/or a vertical drive circuit 620 modulate the direction in which scanning mirror 610 is deflected to cause output beam 120 to generate a raster scan 626, thereby creating a displayed image, for example on a projection surface 124. A display controller 622 controls horizontal drive circuit 618 and vertical drive circuit 620 by converting pixel information of the displayed image into laser modulation synchronous to the scanning platform 114 to write the image information as a displayed image based upon the position of the output beam 120 in raster pattern 626 and the corresponding intensity and/or color information at the corresponding pixel in the image. Display controller 622 may also control other various functions of scanned beam display 100.

In one or more embodiments, for two dimensional scanning to generate a two dimensional image, a horizontal axis may refer to the horizontal direction of raster scan 626 and the vertical axis may refer to the vertical direction of raster scan 626. Scanning mirror 610 may sweep the output beam 120 horizontally at a relatively higher frequency and also vertically at a relatively lower frequency. The result is a scanned trajectory of laser beam 120 to result in raster scan 626. The fast and slow axes may also be interchanged such that the fast scan is in the vertical direction and the slow scan is in the horizontal direction. However, the scope of the claimed subject matter is not limited in these respects.

In one or more particular embodiments, the scanned beam display 100 as shown in and described with respect to FIG. 1 may comprise a pico-projector developed by Microvision Inc., of Redmond, Wash., USA, referred to as PicoP™. In such embodiments, light source 110 of such a pico-projector may comprise red, green, and blue lasers, with a lens near the output of the respective lasers that collects the light from the laser and provides a very low numerical aperture (NA) beam at the output. The light from the lasers may then be combined with dichroic elements into a single white beam 112. Using a beam splitter and/or basic fold-mirror optics, the combined beam 112 may be relayed onto biaxial MEMS scanning mirror 610 disposed on scanning platform 114 that scans the output beam 120 in a raster pattern 626. Modulating the lasers synchronously with the position of the scanned output beam 120 may create the projected image. In one or more embodiments the scanned beam display 100, or engine, may be disposed in a single module known as an Integrated Photonics Module (IPM), which in some embodiments may be 7 millimeters (mm) in height and less than 5 cubic centimeters (cc) in total volume, although the scope of the claimed subject matter is not limited in these respects.

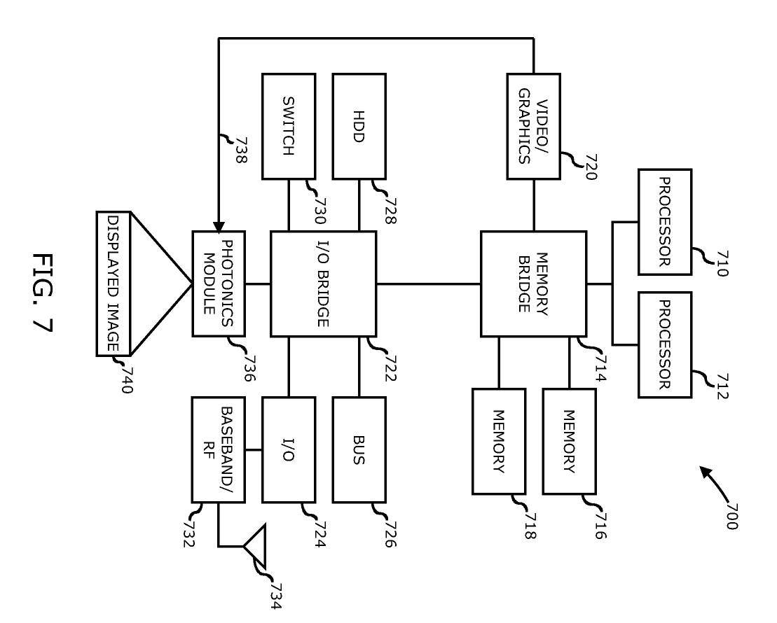

FIG. 7 is a diagram of an information handling system having a scanned beam display utilizing a microlens array (MLA) in combination with a collection lens to control the beam profile in accordance with one or more embodiments. Information handling system 700 of FIG. 7 may tangibly embody scanned beam display 100 as shown in and described with respect to FIG. 1. Although information handling system 700 represents one example of several types of computing platforms, including cell phones, personal digital assistants (PDAs), netbooks, notebooks, internet browsing devices, tablets, and so on, information handling system 700 may include more or fewer elements and/or different arrangements of the elements than shown in FIG. 7, and the scope of the claimed subject matter is not limited in these respects.

Information handling system 700 may comprise one or more processors such as processor 710 and/or processor 712, which may comprise one or more processing cores. One or more of processor 710 and/or processor 712 may couple to one or more memories 716 and/or 718 via memory bridge 714, which may be disposed external to processors 710 and/or 712, or alternatively at least partially disposed within one or more of processors 710 and/or 712. Memory 716 and/or memory 718 may comprise various types of semiconductor based memory, for example volatile type memory and/or non-volatile type memory. Memory bridge 714 may couple to a video/graphics system 720 to drive a display device, which may comprise photonics module 736, coupled to information handling system 700. Photonics module 736 may comprise scanned beam display 100 of FIG. 1. In one or more embodiments, video/graphics system 720 may couple to one or more of processors 710 and/or 712 and may be disposed on the same core as the processor 710 and/or 712, although the scope of the claimed subject matter is not limited in this respect.

Information handling system 700 may further comprise input/output (I/O) bridge 722 to couple to various types of I/O systems. I/O system 724 may comprise, for example, a universal serial bus (USB) type system, an IEEE 1394 type system, or the like, to couple one or more peripheral devices to information handling system 700. Bus system 726 may comprise one or more bus systems such as a peripheral component interconnect (PCI) express type bus or the like, to connect one or more peripheral devices to information handling system 700. A hard disk drive (HDD) controller system 728 may couple one or more hard disk drives or the like to information handling system, for example Serial Advanced Technology Attachment (Serial ATA) type drives or the like, or alternatively a semiconductor based drive comprising flash memory, phase change, and/or chalcogenide type memory or the like. Switch 730 may be utilized to couple one or more switched devices to I/O bridge 722, for example Gigabit Ethernet type devices or the like. Furthermore, as shown in FIG. 7, information handling system 700 may include a baseband and radio-frequency (RF) block 732 comprising a baseband processor and/or RF circuits and devices for wireless communication with other wireless communication devices and/or via wireless networks via antenna 734, although the scope of the claimed subject matter is not limited in these respects.

In one or more embodiments, information handling system 700 may include photonics module 736 that may correspond scanned beam display 100 of FIG. 1, and which may include any one or more or all of the components of scanned beam display 100 such as controller 622, horizontal drive circuit 618, vertical drive circuit 620, scanning platform 114, collection lens 116, microlens array 118, and/or light source 110. In one or more embodiments, photonics module 736 may be controlled by one or more of processors 710 and/or 712 to implement some or all of the functions of controller 622 of FIG. 6. In one or more embodiments, photonics module 736 may comprise a MEMS based scanned laser display for displaying an image projected by photonics module 736 where the image may likewise be represented by displayed image 740. In one or more embodiments, a scanned beam projector may comprise video/graphics block 720 having a video controller to provide video information 738 to photonics module 736 to display an image represented by displayed image 740. In one or more embodiments, photonics module 736 may utilize a collection lens 116 and microlens array 118 as discussed herein. However, these are merely example implementations for photonics module 736 within information handling system 700, and the scope of the claimed subject matter is not limited in these respects.

Although the claimed subject matter has been described with a certain degree of particularity, it should be recognized that elements thereof may be altered by persons skilled in the art without departing from the spirit and/or scope of claimed subject matter. It is believed that the subject matter pertaining to a beam profile control in a scanned beam display and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. An apparatus, comprising:
a light source to generate a beam to be scanned;
a scanning platform to scan the beam in a selected pattern to project an image onto a projection surface; and
a collection lens and microlens array to shape the beam to a desired beam profile without significantly increasing a divergence angle of the beam with increasing distance from the projection surface.

2. An apparatus as claimed in claim 1, wherein the collection lens and the microlens array comprise a single unit.

3. An apparatus as claimed in claim 1, wherein the collection lens and the microlens array comprise two separate units that are coupled together.

4. An apparatus as claimed in claim 1, wherein the beam passes through the microlens array before passing through the collection lens.

5. An apparatus as claimed in claim 1, wherein the beam passes through the microlens array after passing through the collection lens.

6. An apparatus as claimed in claim 1, wherein microlens array and collection lens shape a profile of the beam by moving beam energy away from a beam center and toward a periphery of a spot of the beam.

7. An apparatus as claimed in claim 1, wherein the microlens array is disposed in a path of the beam before the beam impinges on the scanning platform.

8. An apparatus as claimed in claim 1, wherein the microlens array is disposed in a path of the beam after the beam impinges on the scanning platform.

9. An apparatus as claimed in claim 1, wherein the scanning platform comprises a microelectromechanical machine system (MEMS) scanner, a liquid crystal on silicon (LCOS) device, or a digital light processor (DLP), or combinations thereof.

10. A method, comprising:
generating a beam to be scanned with a light source;
shaping a profile of the beam to move energy away from a center of the beam; and
scanning the beam in response to image information to display an image on a projection surface;
wherein said shaping is performed without significantly increasing a divergence angle of the beam with increasing distance away from the projecting surface.

11. A method as claimed in claim 10, wherein the beam profile is shaped to have a generally Gaussian function profile.

12. A method as claimed in claim 10, wherein said shaping occurs in a near field to result in an increasing C6 value.

13. A method as claimed in claim 10, wherein said shaping occurs before said scanning.

14. A method as claimed in claim 10, wherein said shaping occurs after said scanning.

15. A method as claimed in claim 10, wherein said shaping occurs via a microlens array.

16. An information handling system, comprising:
a processor and a memory coupled to the processor to store image information stored therein; and
a display coupled to the processor to display an image in response to the image information stored in the memory, wherein the display comprises:
a light source to generate a beam to be scanned;
a scanning platform to scan the beam in a selected pattern to project the image onto a projection surface; and
a collection lens and microlens array to shape the beam to a desired beam profile without significantly increasing a divergence angle of the beam with increasing distance from the projection surface.

17. An information handling system as claimed in claim 16, wherein the collection lens and the microlens array comprise a single unit.

18. An information handling system as claimed in claim 16, wherein the collection lens and the microlens array comprise two separate units that are coupled together.

19. An information handling system as claimed in claim 16, wherein the beam passes through the microlens array before passing through the collection lens.

20. An information handling system as claimed in claim 16, wherein the beam passes through the microlens array after passing through the collection lens.
